(19) United States
(12) Patent Application Publication
(10) Pub. No.: US 2002/0099110 A1
(43) Pub. Date: Jul. 25, 2002

(54) RADIATION-CURABLE COATING COMPOSITION

(76) Inventors: TYSON NORLIN, MELROSE PARK, IL (US); JAMES J. SCHOUTEN, ELMHURST, IL (US); JOHN SOUTHWELL, GLENN ELLYN, IL (US); ANTHONY TOUSSAINT, CHICAGO, IL (US)

Correspondence Address: PILLSBURY MADISON & SUTRO LLP, INTELLECTUAL PROPERTY GROUP, 1100 NEW YORK AVE NW, NINTH FLOOR EAST TOWER, WASHINGTON, DC, 20005-3918, US

(21) Appl. No.: 09/475,024

(22) Filed: Dec. 30, 1999

(51) Int. Cl. C08F 2/46; D02G 3/00

(52) U.S. Cl. 522/35; 428/378; 522/8; 522/42; 522/92; 522/96

(57) ABSTRACT

The present invention relates to radiation-curable compositions that after cure release fully from a matrix material while maintaining other desirable qualities of radiation-cured compositions. These radiation-curable compositions include at least one radiation-curable oligomer and at least one oligomeric photoinitiator. These compositions can be formulated, for example, to serve as protective coatings for substrates manufactured from a wide variety of including glass, plastic, ceramic, metal and wood. The compositions of the present invention are preferably designed for use as an optical fiber coating (including inner primary and, colored or uncolored, secondary coatings as well as other coatings which include inks, matrix materials and the like) or related optical fiber protective materials.

### FIELD OF THE INVENTION

The present invention relates to radiation-curable coating compositions, uses and preparation thereof, that after cure provide improved release from a matrix or bundling material. In particular, the invention relates to compositions that can be applied to and cured as a covering layer of optical fiber coatings and coated glass fibers that allows easy stripping when a plurality of units with the covering layer are bonded together by a further covering layer.

### BACKGROUND OF THE INVENTION

Radiation-curable compositions are extensively used in the optical fiber industry during the production of optical fibers and cables. Optical fibers are routinely coated with at least one radiation-curable composition typically immediately after the optical fiber is manufactured in a draw tower so as to preserve the pristine character of the optical fiber. Immediately after the coating is applied to the fiber, the coating can be rapidly cured by exposure to radiation (commonly ultraviolet light). Radiation-curable compositions may also be used as matrix materials to bundle together individual coated optical fibers into ribbons, and as bundling materials for bundling ribbons for optical fiber cables, and similar assemblies.

For purposes of multi-channel transmission, optical fiber assemblies containing a plurality of coated optical fibers have been used. Optical fiber assemblies provide a modular design which simplifies the installation and maintenance of optical fibers by eliminating the need to handle individual optical fibers. Examples of optical fiber assemblies include ribbon assemblies and cables. A typical optical fiber assembly is made of a plurality of coated optical fibers which are bonded together in a matrix material. For example, the matrix material can encase the optical fibers, or the matrix material can edge-bond the optical fibers together.

Coated optical fibers for use in optical fiber assemblies are usually coated with an outer colored layer, called an ink coating or secondary coating, or alternatively a colorant is added to the outer coating to facilitate identification of the individual coated optical glass fibers. Such ink coatings and colored outer coatings are well known in the art. Thus, the matrix material which binds the coated optical fibers together contacts the outer ink layer if present, or the colored outer coating. It is important that the outer ink layer release easily from the matrix material in order to facilitate handling of the optical fiber assembly.

Because a variety of competing characteristics are desired in optical fiber coating systems, multiple layers of coatings are routinely employed in optical fiber production. These typically include a soft inner primary coating and a tougher outer primary coating which provides a more durable exterior for the optical fiber. The outer primary (or secondary) coating may include a color which offers an identifier when coated onto an optical fiber. Examples of radiation-curable primary coatings are disclosed in U.S. Pat. No. 5,336,563 to Coady et al., the entire disclosure of which is hereby incorporated by reference. Additional aspects of optical fiber coating technology are disclosed in U.S. Pat. No. 5,199,098 to Nolan et al.; U.S. Pat. No. 4,923,915 to Urruti et al.; U.S Pat. No. 4,720,529 to Kimura et al.; and U.S. Pat. No. 4,474,830 to Taylor et al., the entire disclosures of each are herein incorporated by reference.

### SUMMARY OF THE INVENTION

The present invention provides radiation-curable coating compositions, uses and preparation thereof, that have improved release from a matrix material after cure. The coating formed from a composition including an oligomeric photoinitiator releases from a matrix or bundling material in contact with the coating more readily than a coating formed from the same composition in the absence of the oligomeric photoinitiator. The compositions can also facilitate spooling of optical fibers. These radiation-curable compositions include a radiation-curable oligomer, and an oligomeric photoinitiator. The composition is applied to the substrate and cured. The compositions of the invention are preferably designed for use as a colored or uncolored optical fiber secondary coating or related optical fiber protective materials such as inks or matrix materials. Such optical fiber coatings have their own set of unique performance requirements, which distinguish them from conventional applications.

### DETAILED DESCRIPTION OF THE PRESENT INVENTION

The radiation-curable coating compositions of the present invention are not particularly limited by how they are prepared or whether the coating contains colorant or not or other conventional release additives (such as silicone oils) or not or is a secondary coating, matrix material or some other coating. Any conventional process and equipment suitable for this purpose may be employed. Blends of oligomers, monomer diluents, and other ingredients can be used to tailor properties to achieve the design criteria for the given application.

A key characteristic of the present invention is the ability to formulate compositions that, upon cure, exhibit improved release properties (including easy and/or full release) from another covering layer, such as a matrix or bundling material or any other material applied to the surface of the subject composition. Not wanting to be limited by any particular theory, it is believed that this results from the inclusion of an oligomeric photoinitiator in the radiation-curable composition of the invention. The invention also provides compositions that form cured coatings on optical fibers that have good spooling properties. The spooling properties of optical fibers having a cured coating can be improved by the addition of a silicone resin or a blend of silicone resins. Mixtures of colorants can be included in the compositions.

The radiation-curable coating compositions of the present invention are now described in more detail.

(A) Radiation-Curable Oligomer

The radiation-curable oligomer useful in the radiation-curable composition (hereinafter “oligomer” or “oligomer compound”) is composed of one or more types of oligomers. The oligomer compound, or mixture of such oligomer compounds, has on average 1.2 or more, preferably from 1.2 to 4, and more preferably from 1.5 to 2.5, polymerizable unsaturated groups per oligomer compound. The polymerizable unsaturated group preferably includes radically polymerizable ethylenically unsaturated groups, for example, (meth)acrylate, vinyl ether, vinyl, acrylamide, maleate, fumarate, and the like. The preferred ethylenically unsaturated groups are (meth)acrylate, with acrylate groups being most preferred, because acrylate-functional oligomers result in a coating composition having a faster cure speed.

The principal chain, or backbone, of suitable oligomers include those constituted of a wide variety of polymers including those derived from polyether polyols, polyester polyols, polycaprolactone polyols, polyolefin (hydrocarbon) polyols, polycarbonate polyols, acrylic polyols and the like. Preferably, the backbone is derived from polyether polyols, polyester (including alkyds) polyols, polycarbonate polyols and/or hydroxy functional acrylates. These polyols may be used either singly or in combinations of two or more. It is especially desirable that the radiation-curable oligomer contains a polyether, polyester, and/or acrylated acrylics oligomers either with or without urethane groups (with urethane groups being preferred).

Either all or a part of the radiation-curable oligomer may be a polyether urethane-based oligomer. The radiation-curable oligomer preferably contains a polyether polyol urethane-based polymer, which may either be composed entirely of polyether polyol urethane-based polymers or include polyether polyol urethane-based polymers as a major component as well as other polymers corresponding to the radiation-curable oligomer. Examples of other oligomers include polyester polyol urethane-based oligomers, polycaprolactone polyol urethane-based oligomers, and the like.

Backbones derived from multiple polyols can be linked by a variety of means including urethane linkages. Useful oligomers include those which contain two or more urethane bonds, and preferably 2-10 urethane bonds. If the number of urethane bonds is less than two, the tenacity of the resulting cured product decreases, which tends to produce a transmission loss of optical fiber when the composition is used as a coating material for optical fibers.

The oligomers useful as the radiation-curable oligomer include those produced, for example, by a reaction of: (a) a polyether polyol (hereinafter called “polyether polyol (a)”), obtained, for example, by a ring-opening reaction of cyclic ethers; (b) a polyisocyanate (hereinafter called “polyisocyanate (b)”); and (c) a polymerizable unsaturated group containing compound (hereinafter called “compound (c)”) containing both an active group (such as a labile hydrogen) capable of reacting with the isocyanate group and a polymerizable unsaturated group. Cyclic ethers include ethylene oxide, propylene oxide, butene-1-oxide, isobutene oxide, 3,3-bischloromethyl oxetane, tetrahydrofuran, 2-methyl tetrahydrofuran, 3-methyl tetrahydrofuran, dioxane, trioxane, tetraoxane, cyclohexene oxide, styrene oxide, epichlorohydrin, glycidyl methacrylate, glycidyl acrylate, allyl glycidyl ether, allyl glycidyl carbonate, butadiene monoxide, isoprene monoxide, vinyl oxetane, vinyl tetrahydrofuran, vinyl cyclohexene oxide, phenyl glycidyl ether, butyl glycidyl ether, and glycidyl benzoate.

The above polyether polyol (a) can be a polyol possessing a polyoxyalkylene structure composed of a polyoxyalkylene group having 2-10 carbon atoms as a repetitive unit and is preferably a diol.

Examples of diols possessing the above polyoxyalkylene structure include polyglycol compounds such as polyethylene glycol, polypropylene glycol (PPG), polytetramethylene glycol (PTMG), polyheptamethylene glycol, polyhexamethylene glycol, polydecamethylene glycol, and the like; and polyether diols obtained by ring-opening copolymerization of two or more ionic polymerizable cyclic compounds.

Also, polyether diols produced by ring-opening copolymerization of the above polymerizable cyclic compound and a cyclic imine such as ethylene imine or the like, a cyclic lactone such as p-propiolactone or glycolic acid lactide or the like, or cyclic siloxanes such as dimethylcyclopolysiloxane or the like can be used.

Examples of the specific combinations of two or more polymerizable cyclic compounds include combinations of tetrahydrofuran and propylene oxide (PPTG), tetrahydrofuran and 2-methyl tetrahydrofuran, tetrahydrofuran and 3-methyl tetrahydrofuran, tetrahydrofuran and ethylene oxide, and propylene oxide and ethylene oxide. Two or more ion-polymerizable cyclic compounds may be combined at random in the resulting ring-opening polymer.

The aforementioned diols having a polyoxyalkylene structure are commercially available under the trademarks, for example, PTMG1000, PTMG2000 (manufactured by Mitsubishi Chemical Corp.), PPG1000, PPG2000, EXCENOL2020, EXCENOL1020 (manufactured by Asahi Oline Co., Ltd.), PEG1000, Unisafe DC1100, Unisafe DC1800 (manufactured by Nippon Oil and Fats Co., Ltd.), PPTG2000, PPTG1000, PTG400, PTGL 2000 (manufactured by Hodogaya Chemical Co., Ltd.), and the like.

In the foregoing production, a diol having no polyoxyalkylene structure and/or a diamine may be used either individually or in combination with the polyether polyol (a). Here, as examples of a diol having no polyoxyalkylene structure, a polyester diol, polycaprolactone diol, polycarbonate diol, and the like, are given. Examples of a polyester diol include those obtained by reacting polyhydric alcohol, such as ethylene glycol, propylene glycol, tetramethylene glycol, 1,6-hexane diol, neopentyl glycol, or 1,4-cyclohexanedimethanol, with a polybasic acid such as phthalic acid, isophthalic acid, terephthalic acid, maleic acid, fumaric acid, adipic acid, sebacic acid, or the like. Examples of a polycaprolactone diol include polycaprolactone diols obtained by reacting ε-caprolactone with a diol such as ethylene glycol, tetramethylene glycol, 1,6-hexane diol, neopentyl glycol, 1,4-butane diol, or the like. Examples of polycarbonate diols, polycarbonate diols of polytetrahydrofuran, polycarbonates of 1,6-hexane diol, and polycaprolactone diols are commercially available under the trademarks DN-980, DN-981, DN-982, DN-983 (manufactured by Nippon Polyurethane Industry Co., Ltd.), PC-8000 (manufactured by PPG in US), and the like.

Exemplary polyolefin diols include preferably linear or branched hydrocarbons containing a plurality of hydroxyl end groups. Preferably, the hydrocarbon is a non-aromatic compound containing a majority of methylene groups (—CH₂—) and which can contain internal unsaturation and/or pendent unsaturation. Fully saturated, for example, hydrogenated hydrocarbons, are preferred because the long term stability of the cured coating increases as the degree of unsaturation decreases. Examples of hydrocarbon diols include, for example, hydroxyl-terminated, fully or partially hydrogenated 1,2-polybutadiene; 1,4- and 1,2-polybutadiene copolymers, 1,2-polybutadiene-ethylene or -propylene copolymers, polyisobutylene polyol; mixtures thereof, and the like. Preferably, the hydrocarbon diol is a substantially hydrogenated or fully hydrogenated 1,2-polybutadiene or 1,2 -polybutadiene-ethene copolymer. Acrylic polyols are the polymerization products of acrylate esters, including those with a hydroxyl group.

The aforementioned polyisocyanate (b) is a compound containing 2 to 6 isocyanate groups, with diisocyanates being preferred. Specific examples of the polyisocyanate (b) include 2,4-tolylene diisocyanate, 2,6-tolylene diisocyanate, 1,3 -xylene diisocyanate, 1,4-xylene diisocyanate, 1,5-naphthalene diisocyanate, p-phenylene diisocyanate, 3,3′-dimethyl-4,4′-diphenylmethane diisocyanate, 4,4′-diphenylmethane diisocyanate, 3,3′-dimethylphenylene diisocyanate, 4,4′-biphenylene diisocyanate, hexamethylene diisocyanate, isophorone diisocyanate, dicyclohexylmethane diisocyanate, methylene bis(4-cyclohexylisocyanate), hydrogenated diphenylmethane diisocyanate, 2,2,4-trimethylhexamethylene diisocyanate, bis(2-isocyanatoethyl) fumarate, 6-isopropyl-1,3-phenyl diisocyanate, 4-diphenylpropane diisocyanate, and lysine diisocyanate.

The above-noted compound (c) having a group reactive with an isocyanate and a polymerizable unsaturated group, may include, for example, (meth)acrylic type compounds having at least one hydroxyl group. Specific examples of the compound (c) include 2-hydroxyethyl (meth)acrylate, 2-hydroxypropyl (meth)acrylate, 2 -hydroxyoctyl (meth)acrylate, pentaerythritol tri(meth)acrylate, glycerol di(meth)acrylate, dipentaerythritol monohydroxy penta(meth)acrylate, 1,4-butanediol mono(meth)acrylate, 4-hydroxycyclohexyl (meth)acrylate, 1,6-hexanediol mono(meth)acrylate, neopentyl glycol mono(meth)acrylate, trimethylolpropane di(meth)acrylate, trimethylolethane di(meth)acrylate, and (meth)acrylates represented by the following formulae (1) and (2):

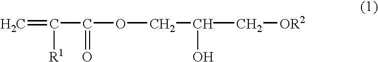

wherein

R¹ represents a hydrogen atom or a methyl group, and

R² represents a hydrogen atom or an alkyl, aryl, hydroxyalkyl, or hydroxyaryl group.

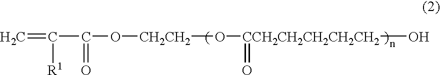

wherein R¹ is the same as defined above and n denotes an integer from 1 to 5. Among these groups, 2-hydroxylethyl (meth)acrylate is preferred.

The radiation-curable oligomer may be prepared by reacting at least one polyol (a) with at least one polyisocyanate (b) and at least one compound (c) in accordance with procedures and in proportions known for producing such products.

As for the oligomer forming reaction of the polyether polyol (a) with the polyisocyanate (b) and the compound (c), for example, when a diol compound is reacted with a diisocyanate compound and a compound having an ethylenic unsaturated group, it is desirable to use a urethanization catalyst such as copper naphthanate, cobalt naphthanate, zinc naphthanate, dibutyltin dilaurate, triethyl amine, 1,4-diazabicyclo[2.2.2]octane, 2,6,7-trimethyl-1,4-diazabicyclo[2.2.2]octane, or the like in an amount of 0.01 to 1 part by weight of 100 parts of the total amount of reaction components. Preferably, the catalyst is dibutyltin dilaurate. This reaction may be carried out at any suitable temperature, typically this reaction is performed at a temperature of 10 to 90° C., and preferably 30 to 80° C.

The proportionate amount of the radiation-curable oligomer in the composition, relative to the total composition, of the invention is generally from 5 to 95% by weight, preferably 10 to 90% by weight, and more preferably from 20 to 60% by weight. In certain embodiments, the composition can include between 5 to 95% by weight, preferably 10 to 90% by weight, and more preferably from 15 and 50% by weight of a second radiation-curable oligomer. If the proportion of the radiation-curable oligomer is too small, the elongation of the resulting cured product from the composition decreases, whereas if the proportion is too large, the viscosity of the composition increases, whereby the handling characteristics tend to be impaired.

Oligomer components can be selected to attain the optimal balance of properties for a given application demanded by the ultimate optical fiber cable manufacturer. The particular properties of interest in the present invention, however, are releasability from a further covering layer, such as a matrix or bundling material in general, and the oligomer should be tailored with this goal in mind. Additional disclosure about suitable components useful in conventional polyurethane synthesis can be found in, for example, Polyurethane Handbook, G. Oertel (Ed.), Hanser Publishers, 1985 (e.g., Chapter 2, “Chemical and Physical-Chemical Principles of Polyurethane Chemistry,” and Chapter 3, “Raw Materials”), the complete disclosure of which is hereby incorporated by reference.

The number average molecular weight of the oligomer is not particularly limited but can be, for example, about 750-10,000 g/mole, preferably 800-7,000 g/mole and more preferably about 1,000-5,000 g/mole. Molecular weight can be selected to achieve the desired viscosity, modulus, solvent resistance, oxidative stability, and other important properties. Oligomer molecular weight and its distribution can be determined by gel permeation chromatography.

Reactive diluents can be included in the composition. The reactive (monomer) diluent functions to decrease the viscosity of the oligomer and tailor the final coating properties like, for example, refractive index and polarity (moisture absorption). The term “monomer diluent” includes monofunctional compounds and compounds containing two or more functional groups capable of polymerization. They also function to adjust the mechanical properties and crosslink density of the compositions and determine whether the compositions can serve as, for example, inner primary, outer secondary, single coatings or matrix materials. Aromatic diluents like phenoxyethyl acrylate or ethoxylated nonylphenol acrylate tend to raise the refractive index of the material. Aliphatic diluents like lauryl acrylate impart hydrophobicity, and diluents with long chain alkyl groups also tend to soften the composition. Polar diluents like N-vinyl caprolactam can improve room temperature mechanical properties by hydrogen bonding. Multi-functional diluents like trimethylolpropane triacrylate can increase cure speed and crosslink density. Formulations can be tailored with non-polar diluents to minimize water absorption because water generally has a detrimental impact on fiber. Preferably, the functional group present in the monomer diluent is capable of copolymerizing with the radiation-curable functional group present on the radiation-curable oligomer.

The diluent can be a conventional monomer or mixture of monomers having, for example, an acrylate functionality and an alkyl (e.g., a C₄-C₂₀ alkyl) or polyether moiety. Particular examples of suitable monomer diluents include: isodecyl acrylate, isooctyl acrylate, hexylacrylate, 2-ethylhexylacrylate, isobornylacrylate, decyl-acrylate, laurylacrylate, stearylacrylate, 2-ethoxyethoxy-ethylacrylate, laurylvinylether, epoxy acrylate, 2-ethylhexylvinyl ether, N-vinyl formamide, N-vinyl caprolactam, N-vinylpyrrolidone, and the like.

Another type of diluent includes those compounds having an aromatic group.

Particular examples of monomer diluents having an aromatic group include:

phenoxyethylacrylate,

ethoxylated nonylphenolacrylate,

ethyleneglycolphenylether-acrylate, polyethyleneglycolphenyletheracrylate,

polypropyleneglycolphenylether-acrylate, and

alkyl-substituted phenyl derivatives of the above monomers, such as polyethyleneglycolnonylphenol-etheracrylate.

The diluent can also comprise a monomer having two or more functional groups capable of polymerization. Particular examples of such monomers include:

ethoxylated bisphenol A diacrylate,

C₂-C₁₈ hydrocarbon-dioldiacrylates,

C₃-C₁₈ hydrocarbon triacrylates, and the polyether analogues thereof, and the like, such as 1,6-hexanedioldiacrylate, trimethylolpropane tri-acrylate, hexanedioldivinylether, triethylene-glycoldiacrylate, pentaerythritol-triacrylate, and tripropyleneglycol diacrylate.

The diluent can be a monomer selected from the groups consisting of phenoxyethyl acrylate, isobomyl acrylate, epoxy acrylate and isodecyl acrylate. The diluent system may include other diluents such as those listed in the aforementioned U.S. Pat. No. 5,336,563 and in V. V. Krongauz and A. J. Tortorello, J. Appl. Polym. Sci., 57 (1995)1627-1636. Ethoxylated bisphenol A diacrylate can be particularly useful for formulating outer secondary coatings, inks and matrix materials. The person skilled in the art can tailor coating mechanical properties by selection of conventional diluents to prepare relatively soft or relatively hard coatings or other types of protective materials. The composition can include 0-40 wt % epoxy acrylate.

In many cases, mixtures of diluent compounds are needed to obtain optimal properties. Suitable diluents include, for example, (meth)acrylate compounds, although acrylate compounds are preferred.

The diluents can include monomers having a level of purity greater than 95%, preferably between 97% to 99.5% as measured by gas chromatography using an 11 meter RT×200 trifluoropropylmethyl polysiloxane column, with a flame ionization detector, an injection temperature of 200° C., and an initial column temperature of 90° C. for two minutes, followed by heating to 270° C. at a rate of 8° C. per minute and a detector temperature of 300° C. Suitable diluents can also include monomers that are substantially free of polymerization inhibitors and reaction catalysts, in particular, monomer diluents having an organotin catalyst level of less than 100 ppm, more preferably, less than 10 ppm. Preferred diluents suitable for use in the radiation-curable compositions of the invention include those which have APHA (ASTM D-1209) color values of less than 40, more preferably less than 25. Particularly preferred diluents include those which comply with two or more of the high-purity standards set forth (e.g., gas chromatography purity standard, the APHA standard and/or the substantially-free of polymerization inhibitor and reaction catalyst standard).

The diluent compound molecular weight is not particularly limited but is generally below about 1,000 g/mol. The oligomer diluent, however, may itself contain some oligomeric character such as repeating alkoxy groups like ethyleneoxy or propyleneoxy in an alkoxylated alkylphenol acrylate diluent.

The total amount of diluent is not particularly limited, but will be selected by the person skilled in the art to achieve the advantages of the present invention for a particular application. The total amount of diluent can be, for example, between about 10 wt % and about 90 wt %, and preferably between about 10 wt % and about 60wt %.

After dilution of oligomer with diluent, the viscosity of the uncured composition is preferably less than about 12,000 mPa·s but greater than about 2,000 mPa·s, and preferably, between about 3,000 and about 8,000 mPa·s at 25° C. The viscosity is preferably stable over time so that long shelf life is attained. For example, after storing the composition for one month at 40° C., the viscosity of the composition increases by less than 20%. Additives in optical fiber coatings are preferably selected to not interfere with shelf life.

(B) Oligomeric Photoinitiator

Photoinitiators increase cure speed of photo-curable compositions. According to the present invention, it has been found that including an oligomeric photoinitiator in the composition improves the release quality of the coating from a matrix material. The oligomeric photoinitiator includes a plurality radiation-absorbing groups that generate radicals upon exposure to radiation. Preferably, the oligomer includes 3 or more, preferably 5-100, radiation-absorbing groups and has a molecular weight of at least 800 g/mol. Specifically, oligomeric photoinitiators can include an aryl group, preferably an arylketone group.

Suitable oligomeric photoinitiators have a backbone constructed from 2 or more monomeric units, preferably 3 to 50 monomeric units. A monomeric unit of the oligomer can include any of a variety of monomers including styrene, preferably alpha-methyl styrene. The backbone of the oligomeric backbone may include any suitable polymer units including a polyester, polyether, polycarbonate, polyolefin, polysiloxane, and/or polyacrylate units. In particular, the oligomeric photoinitiator can include an oligomer containing a phenyl hydroxyalkyl ketone group, preferably a phenyl alpha-hydroxyalkyl ketone group. For example, the oligomeric photoinitiator can include an oligomer of 2-hydroxy-2-methyl-1-(4-(1-methylvinyl)phenyl)-1 -propanone as well as 2-hydroxy-2-methyl-1-phenyl-1-propanone. The oligomeric photoinitiator can include Esacure KIP 100F, available from Sartomer Corporation. Other photoinitiators, such as conventional type I and type II photoinitiators can be combined with the oligomeric photoinitiator in the radiation-curable composition.

(C) Additives

The present compositions can comprise conventional additives. Many different types of additives in optical fiber coatings are known, and the present invention is not particularly limited thereby. The additive should not unduly interfere with the effectiveness of the oligomeric photoinitiator of the present invention.

Relevant disclosure concerning suitable additives is provided in, for example, the aforementioned U.S. Pat. Nos. 5,336,563, 5,093,386, 4,992,524, and 5,146,531. Possible additives include, but are not limited to silane adhesion promoters, photoinitiators, antioxidants, UV stabilizers, UV absorbers, slip agents and the like.

Conventional photoinitiators can also be included in the composition. Mixtures of photoinitiators can often provide the optimal amount of surface and through cure. Commonly, there will be a trade-off between rapid cure speed and other desirable properties in the composition. The person skilled in the art can determine the optimal balance of properties. Rapid optical fiber production with UV-cure, however, requires photoinitiator. The total amount of photoinitiator is not particularly limited but will be sufficient, for a given composition and application, to accelerate cure to achieve greater than 90 percent of the ultimate modulus with less than 500 mJ, preferably less than 200 mJ of curing energy. The amount of photoinitiator in the composition can be, for example, between 0 wt % and 10 wt %, preferably, 0.1 wt % to 8 wt %, and more preferably 0.5 wt % to 5 wt %.

Suitable examples of photoinitiators include hydroxymethylphenylpropanone, dimethoxyphenylacetophenone, 2-methyl-1-[4-(methylthio)-phenyl]-2-morpholino-propanone-1, 1-(4-isopropylphenyl)-2-hydroxy-2-methylpropan-1-one, 1-(4-dodecyl-phenyl)-2-hydroxy-2-methylpropan-1-one, diethoxyphenyl acetophenone, and the like. Phosphine oxide photoinitiator types bis-(2,4,6-trimethylbenzoyl)-phenylphosphine oxide, bis-(2,6-dimethylbenzoyl)-phenylphosphine oxide, bisbenzoyl phenylphosphine oxide, bis-(2,6-dimethoxybenzoyl) phenylphosphine oxide, bisbenzoyl (2,4,6-trimethyl)phenylphosphine oxide, and those represented by the following formula:

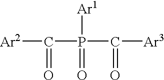

wherein Ar¹ to Ar³ independently represent unsubstituted and/or substituted aromatic groups, said substituted groups may include among other groups hetero groups comprising O, S and/or N. In addition, other suitable photoinitiators include: 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoinpropyl ether, benzoinethyl ether, benzyldimethyl ketal, 1-(4-isopropylphenyl)-2-hydroxy-2-methylpropane-1-one, 2-hydroxy-2-methyl-1-phenylpropane-1-one, thioxanthone, diethylthioxanthone, 2-isopropylthioxanthone, 2-chlorothioxanthone, 2-methyl-1-[4-(methylthio)phenyl]-2-morpholino-propane-1-one, 2,4,6-trimethylbenzoyldiphenylphosphine oxide, bis-(2,6-dimethoxybenzoyl)-2,4,4-trimethylpentylphosphine oxide and commercially available products such as IRGACURE 184, 369, 651, 500, 907, CGI1700, CGI1850, CG24-61 (Ciba-Geigy Ltd.), LUCIRIN LR8728 (BASF), Lucirin TPO (BASF), DAROCURE 1116, 1173 (Merck Co.), UBECRYL P36 (UCB Co.), and the like. Other non-yellowing photoinitiators can be used as discussed in, for example, U.S. Pat. No. 5,146,531, the complete disclosure of which is hereby incorporated by reference. Preferably, the composition includes a mixture comprising an oligomeric photoinitiator and at least one other photoinitiator. In particular, the composition of the present invention preferably comprises an oligomeric photoinitiator containing a phenyl hydroxyalkyl ketone group and a phenyl hydroxyalkyl ketone photoinitiator compound. For example, a mixture of 70% oligo(2-hydroxy-2-methyl-1-(4-(1-methylvinyl)phenyl)-1-propanone) and 30% 2-hydroxy-2-methyl-1-phenyl-1-propanone is available as Esacure KIP 100F from Sartomer Corporation. This photoinitiator can be combined with, for example, bis(2,6-dimethoxybenzoyl)(2,4,4-trimethylpentyl)phosphine oxide. Other suitable photoinitiators are taught in the aforementioned U.S. Pat. No. 5,336,563.

Generally, additives can be present in amounts up to several percent. For example, conventional adhesion promoters such as organofunctional silanes can be used, including acrylate, amino, or mercapto functional silanes. The amounts employed can be about 0.1-5 wt %, and preferably, between about 0.3-3 wt % for coatings to increase adhesion and retain adhesion despite exposure to moisture.

Shelf stabilizers also can be important additives as noted above. Butylated hydroxy toluene (BHT) is a commonly used stabilizing additive. Additives are also useful to tailor the handling characteristics of coated optical fiber. Additives or components which may appear in the final coating include pigments, light sensitive and light absorbing compounds, lubricants, wetting agents, and leveling agents.

These additives may be present in an effective amount that is usual for the additive when used in optical fiber coatings or protective materials. The person skilled in the art can design the use of such additives.

The radiation-curable composition of the invention can be formulated for use as colored UV-curable ink compositions which are color stable. Thin layers of these inks can be coated onto the coated optical fiber to for identification purposes. UV-curable inks are discussed in, for example, “Ultraviolet Color Coding of Optical Fibers—a Comprehensive Study” by S. Vannais and J. Reese in Wire Journal International, October 1991, pgs. 71-76, the complete disclosure of which is hereby fully incorporated by reference. In addition, color change of UV-cured inks is discussed in the publication by D. Szum in Polymers Paint Colour Journal, Nov. 24, 1993, Vol. 183, pgs. 51-53, the complete disclosure of which is hereby incorporated by reference. Colored optical fiber materials are also disclosed in JP 64-22975 and JP-64-22976, the complete disclosures of which are hereby incorporated by reference. Conventional colorants, dyes, and pigments can be used having conventional colors. Colorants are preferably stable to ultraviolet radiation, and pigments are in the form of small particles. The small particles can have diameters of less than 10 microns, preferably less than 5 microns, and more preferably less than 2 microns. Particle size can be reduced by milling.

Pigments can be conventional inorganic or organic pigments as disclosed in, for example, Ullmann's Encyclopedia of Industrial Chemistry, 5th Ed., Vol. A22, VCH Publishers (1993), pages 154-155, the complete disclosure of which is hereby fully incorporated by reference. The pigment can be selected based on, for example, whether the composition is colored secondary, ink coating or matrix material. Ink coatings are typically more heavily pigmented.

General classes of suitable colorants include, among others, inorganic white pigments; black pigments; iron oxides; chromium oxide greens; iron blue and chrome green; violet pigments; ultramarine pigments; blue, green, yellow, and brown metal combinations; lead chromates and lead molybdates; cadmium pigments; titanate pigments; pearlescent pigments; metallic pigments; monoazo pigments; diazo pigments; diazo condensation pigments; quinacridone pigments; dioxazine violet pigment; vat pigments; perylene pigments; thioindigo pigments; phthalocyanine pigments; and tetrachloroisoindolinones; azo dyes; anthraquinone dyes; xanthene dyes; and azine dyes. More particularly, suitable inorganic pigments for the compositions of the present invention include, for example, titanium dioxide, iron oxide, iron silicate, iron cyan blue (or Prussian blue), aluminum powder, cooper-zinc allow powder, and carbon black. Suitable organic pigments include, for example, diarylide yellow, diarylide orange, naphthol AS red, Rubin 4 B calcium salt, salts of basic dyes, phthalocyanine blue, reflex blue, phthalocyanines, and polycyclic pigments. Specific pigments/dyes include, for example, titanium dioxide, carbon black (Degussa Special 4A or Columbian Raven 420), lamp black (General carbon LB#6), phthalo blue G (Sun 249-1282), phthalo blue R (Cookson BT698D), phthalo green B (Sun 264-0238), phthalo green Y (Mobay G5420), light chrome yellow (Cookson Y934D), diarylide yellow (Sun 274-3954), organic yellow (Hoechst H4g), medium chrome yellow (Cookson Y969D), yellow oxide (Pfizer YL02288D), lead-free-yellow (BASF Paliotol 1770), raw umber (Hoover 195), burnt umber (Lansco 3240X), lead free orange (Hoechst RL70), red oxide (Pfizer R2998D), moly orange (Cookson YL988D), arylide red (Hoechst F5RKA), quinacridone red (Ciba RT759D), quinacridone violet (Ciba RT887D), and the like. Fluorescent pigments can be used.

Suitable dyes include polymethine dyes, di and triarylmethine dyes, aza analogues of diarylmethine dyes, aza (18) annulenes (or natural dyes), nitro and nitroso dyes, azo dyes, anthraquinone dyes and sulfur dyes. These dyes are well known in the art.

Polymethine dyes contain an electron donor and an electron acceptor group at opposite ends of the methine chain. Aza nitrogens (−N═) can replace one or more methine groups in the chain. Such dyes include cyanines, hemicyanines, streptocyanines, and oxonols.

Di and triarylmethine dyes have dimethylamino substituents in a para position to the central carbon atom on the rings. Other electron donor groups include primary, secondary, and tertiary amino groups, hydroxyl groups and their conjugate bases. An example of a dimethine dye is Michler's hydrol. In triarylmethine dyes, the H-atom of the central methine group of Michler's hydrol is substituted by an aryl residue. An example of a triarylmethine dye is malachite green. The aryl residue of these dyes may contain an electron donor. An example of such a dye includes crystal violet. The aryl residue may be substituted by a naphthalene system, as in naphthalene green.

In aza analogues of diarlmethine dyes, aza nitrogen groups can be used to replace the methine groups. The central ring can be substituted in a para position to the nitrogen atom with any of the following NH, NR, Nar to form an azine, O to form an oxazine or S to form a thiazine.

Most of the aza (18) annulenes, which are natural dyes, are based on the porphyrin ring system. Such dyes contain a skeleton of 4-pyrrole rings cyclized in their alpha-alpha prime positions by 4 methine groups, and thus have the structural properties of phthalocyanine colorants. Phthalocyanine is a tetra aza derivative of tetrabenzoporphyrin. The copper complex of phthalocyanine and its derivatives, substituted in the benzene ring yield turquoise shades with good fastness properties. Nitro dyes include a nitro group in an o-position to an electron donor, such as hydroxy or amino. Nitro dyes include amido yellow, which can be made by nucleophilic substitution of 2,4-dinitrochlorobenzene with 4-aminodiphenylamine-2-sulfonic acid. Nitroso dyes include a nitroso group in an o-position to an hydroxyl group. An example of a nitroso dye is naphthol yellow, 2, 4-dinitro-1-naphthol-7-sulfonic acid. The azo dyes are well known and include anionic monoazo dyes, aromatic azo compounds, disperse azo dyes, cationic azo dyes, complex forming monoazo dyes, and reactive azo dyes.

The anthraquinone dyes include ionic anthraquinone, anionic anthraquinone, cationic anthraquinone and substituted anthraquinones as disperse dyes. Sulfur dyes are characterized by di and polysulfide bonds between aromatic residues. Sulfur dyes are obtainable by treating aromatic amines, phenols and aminophenols with sulfur and sodium polysulfide or both. An example of a sulfur dye is Condense Sulfur Orange.

The amount of the colorant, pigment, or dye is also conventional and will be determined by such factors as the shade, coloring strength, and fastness of the colorant as well as the dispersibility, rheological properties, and transparency. Also, inks are generally more heavily pigmented than secondary coatings. The amount can be that which is sufficient to impart the required color, and more than that is not generally preferred. The amount of colorant can be, for example, between 0 wt % and wt %, and preferably, 0.25 wt % to 10 wt %, and more preferably, 0.5 wt % to 5 wt %.

The radiation-curable compositions of the present invention may be formulated such that the composition after cure has a modulus as low as 0.1 MPa and as high as 2,000 MPa or more. Those having a modulus in the lower range, for instance, from 0.1 to 10 MPa, preferably 0.1 to 5 MPa, and more preferably 0.5 to less than 3 MPa are typically suitable for inner primary coatings for fiber optics. In contrast, suitable compositions for secondary coatings, inks and matrix materials generally have a modulus of above 50 MPa, with secondary coatings tending to have a modulus more particularly above 100 up to 1,000 MPa, preferably at least 400 MPa, and matrix materials tending to be more particularly between about 50 MPa to about 200 MPa.

Elongation and tensile strengths of these materials can also be optimized depending on the design criteria for a particular use. For cured coatings formed from radiation-curable compositions formulated for use as an inner primary coating on optical fibers, the elongation is typically greater than 100%, more preferably the elongation is at least 110%, more preferably 120%. Thermal mechanical measurements can be used to optimize the glass transition temperature (Tg) which may be from 10° C. down to −70° C. or lower for compositions formulated for use as inner primary coatings and 30° C. to 120° C. or higher, more preferably above 40° C., for compositions designed for use as secondary coatings, inks and matrix materials.

Several particular properties are desirable for the compositions. The primary coating preferably has low water sensitivity and optimized adhesion for ribbon and loose-tube fiber assembly applications. Refractive index should be preferably at least about 1.48. The secondary coating preferably has low hydrogen generation and is relatively haze free. Optical fibers will generally have a diameter of about 125 microns. Coating compositions can be, for example, used at thicknesses of 10-150 microns, and preferably, 20-60 microns. The oligomeric photoinitiator improves the release of the secondary coating from a matrix material, allowing the coating to fully release from the matrix.

The compositions can also include silicone resins, or blends of silicone resins, to improve the spooling properties of coated optical fibers. For example, silicone resins such as DC57 and DC 190, available from Dow Corning, can be included in the radiation-curable composition. The composition can include 0-5 wt % silicone, preferably 0.05-2.0 wt % silicone, and more preferably 0.1 to 1.0 wt % silicone. Increasing the amount of silicone in the composition can decrease the coefficient of friction of the coatings formed from the composition.

The radiation-curable compositions discussed herein can readily be formulated for use in any one of several coating layers present in a ribbon assembly. These include the inner primary coatings and secondary coatings (which may or may not include coloring) on the optical fibers as well as other coatings including inks and matrix materials.

Ribbon assemblies comprising one or more coatings formed from a composition in accordance with the present invention can be advantageously used in various telecommunication systems. Such telecommunication systems typically include ribbon assemblies containing optical glass fibers, in combination with transmitters, receivers, and switches. The ribbon assemblies containing the coated optical glass fibers are the fundamental connecting units of telecommunication systems. The ribbon assembly can be buried under ground or water for long distance connections, such as between cities. The ribbon assembly can also be used to connect directly to residential homes.

The novel ribbon assembly made according to this invention can also be used in cable television systems. Such cable television systems typically include ribbon assemblies containing optical glass fibers, transmitters, receivers, and switches. The ribbon assemblies containing the coated optical glass fibers are the fundamental connecting units of such cable television systems. The ribbon assembly can be buried under ground or water for long distance connections, such as between cities. The ribbon assembly can also be used to connect directly to residential homes.

The novel ribbon assemblies can also be used in a wide variety of technologies, including but not limited to, various security systems, data transmission lines, high density television, and computer appliance systems. These are primarily exhibited, as explained above, in the stripping and cable splicing function, but those operations are nonetheless critical in the establishment of a ribbon/cable network of communication.

### EXAMPLES

The following examples are given as particular embodiments of the invention and to demonstrate the practice and advantages thereof. It is understood that the examples are given by way of illustration and are not intended to limit the specification or the claims that follow in any manner.

Radiation-curable coating compositions were prepared from the mixture of ingredients shown in Tables 1-4.

Definitions of components employed in the following examples:

Oligomer is an oligomer having acrylate groups linked to a backbone by urethane linkages.

CN120Z is an epoxy acrylate oligomer available from Sartomer.

Lucirin TPO is diphenyl (2,4,6-trimethylbenzoyl) phosphine oxide, available from BASF.

Irgacure 184 is 1-hydroxycyclohexyl phenyl ketone, available from Ciba-Geigy.

Esacure KIP 100F is a liquid mixture of 70 wt % oligo(2-hydroxy-2-methyl-1-(4-(1-methylvinyl)phenyl)propanone) and 30 wt % 2-hydroxy-2-methyl-1-phenyl-1-propanone, available from Sartomer Corporation.

DC57 and DC190 are silicone resins, available from Dow Corning.

The properties of the compositions when cured are listed in Table 2.

TABLE 1

| | Comparative | | | |
|---|---|---|---|---|
| | Example A | Example 1 | Example 2 | Example 3 |
| Component | (wt %) | (wt %) | (wt %) | (wt %) |
| Polyester Urethane | 35.00 | 33.60 | 31.92 | 31.85 |
| Acrylate | | | | |
| Ethoxylated | 49.50 | 47.52 | 45.14 | 45.05 |
| bisphenol A epoxy | | | | |
| diacrylate | | | | |
| Trimethylol propane | 11.00 | 10.56 | 10.03 | 10.01 |
| triacrylate | | | | |
| Irgacure 1700 | 4.00 | 3.84 | 3.65 | 3.64 |
| Irganox 1035 | 0.50 | 0.48 | 0.46 | 0.46 |
| Esacure KIP 100F | | 4.00 | 3.80 | 3.79 |
| DC193 | | | | 0.20 |
| White pigment | | | 5.00 | 5.00 |
| dispersion | | | | |
| Release from matrix | No | Yes | Yes | Yes |

TABLE 2

| | Comparative | | | |
|---|---|---|---|---|
| | Example B | Example 4 | Example 5 | Example 6 |
| Component | (wt %) | (wt %) | (wt %) | (wt %) |
| Polyether Urethane | 40.00 | 37.99 | 36.07 | 36.01 |
| Acrylate | | | | |
| CN 120Z | 30.00 | 28.50 | 27.08 | 27.02 |
| Hexane diol | 11.00 | 10.45 | 9.93 | 9.91 |
| diacrylate | | | | |
| Vinyl caprolactam | 4.70 | 4.47 | 4.25 | 4.24 |
| Phenoxyethyl acrylate | 11.00 | 10.45 | 9.93 | 9.91 |
| Lucirin TPO | 2.00 | 1.90 | 1.81 | 1.80 |
| Irgacure 184 | 1.00 | 0.95 | 0.90 | 0.90 |
| Irganox 1035 | 0.30 | 0.29 | 0.28 | 0.27 |
| Esacure KIP 100F | | 5.00 | 4.75 | 4.74 |
| DC193 | | | | 0.20 |
| White pigment | | | 5.00 | 5.00 |
| dispersion | | | | |
| Release from matrix | No | Yes | Yes | Yes |

TABLE 3

| | Comparative | | | |
|---|---|---|---|---|
| | Example C | Example 7 | Example 8 | Example 9 |
| Component | (wt %) | (wt %) | (wt %) | (wt %) |
| Polyether Urethane | 32.50 | 31.85 | 30.26 | 30.19 |
| Acrylate | | | | |
| Ethoxylated | 46.00 | 45.08 | 42.82 | 42.74 |
| bisphenol A epoxy | | | | |
| diacrylate | | | | |
| Hexane diol | 10.00 | 9.80 | 9.31 | 9.29 |
| diacrylate | | | | |
| Phenoxyethyl acrylate | 8.00 | 7.84 | 7.45 | 7.43 |
| Lucirin TPO | 2.00 | 1.96 | 1.86 | 1.86 |
| Irgacure 184 | 1.00 | 0.98 | 0.93 | 0.93 |
| Esacure KIP 100F | | 2.00 | 1.90 | 1.90 |
| Irganox 1035 | 0.50 | 0.49 | 0.47 | 0.46 |
| DC193 | | | | 0.20 |
| White pigment | | | 5.00 | 5.00 |
| dispersion | | | | |
| Release from matrix | No | Yes | Yes | Yes |

TABLE 4

| | Comparative | Example | Example | Example |
|---|---|---|---|---|
| | Example D | 10 | 11 | 12 |
| Component | (wt %) | (wt %) | (wt %) | (wt %) |
| Polyether Urethane | 40.00 | 39.20 | 37.24 | 37.16 |
| Acrylate | | | | |
| CN 120Z | 30.00 | 29.40 | 27.93 | 27.87 |
| Hexane diol | 11.00 | 10.78 | 10.24 | 10.22 |
| diacrylate | | | | |
| Vinyl caprolactam | 4.70 | 4.61 | 4.38 | 4.37 |
| Phenoxyethyl acrylate | 11.00 | 10.78 | 10.24 | 10.22 |
| Lucirin TPO | 2.00 | 1.96 | 1.86 | 1.86 |
| Irgacure 184 | 1.00 | 0.98 | 0.93 | 0.93 |
| Esacure KIP 100F | | 2.00 | 1.90 | 1.90 |
| Irganox 1035 | 0.30 | 0.29 | 0.28 | 0.27 |
| DC193 | | | | 0.20 |
| White pigment | | | 5.00 | 5.00 |
| dispersion | | | | |
| Release from matrix | No | Yes | Yes | Yes |

Test Procedures

Release Test

The secondary formulation was drawn down on a 3 mil thick MYLAR® film attached with masking tape to an 8.5 inch by 11 inch glass plate. The secondary coating was drawn down to a nominal thickness of 3 mils (75 microns) by passing through a Fusion Systems UV conveyor. The cure conditions were as follows: one 300 W/in Fusion “D” bulb, nitrogen inerting, dose of 0.75 J/cm². The matrix (Cabelite® 950-706, commercially available from DSM Desotech) was then drawn down on the surface of the cured secondary at a thickness of 3 mils (75 microns) and cured as follows: one 300 W/in Fusion “D” bulb, nitrogen inerting, dose of 1.00 J/cm². The cured matrix is then scored with a scalpel such that the matrix is cut through, but the secondary remains intact and attached to the MYLAR® substrate. A rectangle is cut in the matrix approximately 0.75 inches wide by 2 inches long. A corner of the matrix is then lifted with the point of the scalpel blade and the matrix rectangle is peeled from the surface of the colored secondary, if possible. Positive release is characterized by the ability to remove the matrix in an intact rectangle with little effort. Negative release is characterized by the inability to either lift the corner of the matrix rectangle at all, or to initiate peel once the corner is freed.

Tensile Strength, Elongation and Modulus Test Method

The tensile strength, elongation and secant modulus of cured samples were tested using a universal testing instrument, Instron Model 4201 equipped with a personal computer and software “Series IX Materials Testing System.” The load cells used were 4.4 kg capacity. The ASTM D638M was followed, with the following modifications.

A drawdown of each material to be tested was made on glass plate and cured using a UV processor. The cured film was conditioned at 22 to 24° C. and 50±5% relative humidity for a minimum of sixteen hours prior to testing.

A minimum of eight test specimens, having a width of 12.7±0.005 mm and a length of 12.7 cm, were cut from the cured film. To minimize the effects of minor sample defects, sample specimens were cut parallel to the direction in which the drawdown of the cured film was prepared. If the cured film was tacky to the touch, a small amount of talc was applied to the film surface using a cotton tipped applicator.

The test specimens were then removed from the substrate. Caution was exercised so that the test specimens were not stretched past their elastic limit during the removal from the substrate. If any noticeable change in sample length had taken place during removal from the substrate, the test specimen was discarded.

If the top surface of the film was talc coated to eliminate tackiness, then a small amount of talc was applied to the bottom surface of test specimen after removal from the substrate.

The average film thickness of the test specimens was determined. At least five measurements of film thickness were made in the area to be tested (from top to bottom) and the average value used for calculations. If any of the measured values of film thickness deviates from the average by more than 10% relative, the test specimen was discarded. All specimens came from the same plate.

The crosshead speed was set to 25.4 mm/min, and the crosshead action was set to “return at break”. The crosshead was adjusted to 50.8 mm jaw separation. The air pressure for the pneumatic grips was turned on and set to approximately 1.5 Kg/cm².

After the Instron test instrument had been allowed to warm-up for fifteen minutes, it was calibrated and balanced following the manufacturer's operating procedures.

The temperature near the Instron instrument was measured and the humidity was measured at the location of the humidity gauge. This was done just before beginning measurement of the first test specimen.

Specimens were only analyzed if the temperature was within the range 23±1.0° C. and the relative humidity was within 50±5%. The temperature was verified as being within this range for each test specimen. The humidity value was verified only at the beginning and the end of testing a set of specimens from one plate.

Each test specimen was tested by suspending it into the space between the upper pneumatic grips such that the test specimen was centered laterally and hanging vertically. Only the upper grip was locked. The lower end of the test specimen was pulled gently so that it has no slack or buckling, and it was centered laterally in the space between the open lower grips. While holding the specimen in this position, the lower grip was locked.

The sample number was entered and sample dimensions into the data system, following the instructions provided by the software package.

The temperature and humidity were measured after the last test specimen from the current drawdown was tested. The calculation of tensile properties was performed automatically by the software package.

The values for tensile strength, % elongation, and secant, or segment, modulus were checked to determine whether any one of them deviated from the average enough to be an “outlier.” If the modulus value was an outlier, it was discarded. If there were less than six data values for the tensile strength, then the entire data set was discarded and repeated using a new plate.

While the invention has been described in detail and with reference to specific embodiments thereof, it will be apparent to those of ordinary skill in the art that various changes and modifications can be made therein without departing from the spirit and scope thereof.

What is claimed is:

1. A radiation-curable composition comprising:
a radiation-curable oligomer, and
an oligomeric photoinitiator.

2. The composition according to claim 1, wherein the oligomeric photoinitiator includes an aryl group.

3. The composition according to claim 1, wherein the oligomeric photoinitiator is derived from an alpha-methyl styrene.

4. The composition according to claim 1, wherein the oligomeric photoinitiator includes an oligomer containing a phenyl hydroxyalkyl ketone group.

5. The composition according to claim 1, wherein the composition further includes a phenyl hydroxyalkyl ketone photoinitiator compound.

6. The composition according to claim 1, further comprising a silicone.

7. The composition according to claim 1, further comprising a blend of silicones.

8. The composition according to claim 1, comprising 5 wt % to 75 wt % of the radiation-curable oligomer.

9. The composition according to claim 1, comprising, relative to the total weight of the composition 10 wt % to 90 wt % of the radiation-curable oligomer, 10 wt % to 90 wt % of a second radiation-curable oligomer, and 0.1 wt % to 10 wt % photoinitiator.

10. The composition according to claim 1, wherein the radiation-curable oligomer includes acrylate, methacrylate or vinylether groups.

11. The composition according to claim 1, wherein the radiation-curable oligomer includes acrylate groups.

12. The composition according to claim 1, wherein the composition has a modulus of at least 100 MPa when cured.

13. The composition according to claim 1, wherein the composition has a modulus of at least 400 MPa when cured.

14. The composition according to claim 1, wherein the composition, when cured, releases from a cured matrix or bundling material in contact with said cured composition.

15. A coated fiber optic comprising a cured coating formed from a composition according to claim 1.

16. A fiber optic ribbon assembly comprising a coating formed from a radiation-curable composition comprising a colorant, a radiation-curable oligomer, and an oligomeric photoinitiator.

17. The assembly according to claim 16, wherein the colorant includes a dye, a pigment and/or an ink.

18. The assembly according to claim 16, wherein the composition further includes an oligomeric photoinitiator containing phenyl hydroxyalkyl ketone group.

19. The assembly according to claim 16, wherein the composition further comprises a silicone.

20. The assembly according to claim 16, wherein the composition further comprises a blend of silicones.

21. The assembly according to claim 16, wherein the coating is a colored secondary or colored matrix material.

22. A coated fiber optic comprising a cured coating formed from a composition comprising an oligomeric photoinitiator including a phenyl hydroxyalkyl ketone group.

23. A method of coating a fiber optic comprising:
applying a radiation-curable composition comprising a radiation-curable oligomer, and an oligomeric photoinitiator to a fiber optic; and
curing the composition.
